(19) United States
(12) Patent Application Publication
(10) Pub. No.: US 2017/0199634 A1
(43) Pub. Date: Jul. 13, 2017

(54) METHODS AND SYSTEMS FOR MANAGING MEDIA CONTENT OF A WEBPAGE

(71) Applicant: SAMSUNG ELECTRONICS CO., LTD., Suwon-si (KR)

(72) Inventors: Ramanujam RAMASWAMY SRINIVASA, Kuvempunagar Mysore (IN); Nagaraju YENDETI, Bangalore (IN); Dipin KOLLENCHERI PUTHENVEETTIL, Bangalore (IN)

(73) Assignee: SAMSUNG ELECTRONICS CO., LTD., Suwon-si (KR)

(21) Appl. No.: 15/401,536

(22) Filed: Jan. 9, 2017

(30) Foreign Application Priority Data
Jan. 8, 2016 (IN) 201641000829

(51) Int. Cl. G06F 3/0482; G06F 3/0486; G06F 3/0488; G06F 3/0481; H04L 29/08; G06F 17/22

(52) U.S. Cl. CPC G06F 3/0482; H04L 67/02; G06F 17/2247; G06F 3/04883; G06F 3/04817; G06F 3/0486

(57) ABSTRACT

A method to couple a media content with a browser to enable the browser and web page to be aware of the interactions performed by the user on the pop-up window. The method of coupling enables the browser to render even a Media Source extension (MSE) video on the pop-up window ensuring browser's capability to track user interactions on the pop-up window.

### CROSS-REFERENCE TO RELATED APPLICATIONS

This application claims priority from Indian Provisional Patent Application No. 201641000829, filed on Jan. 8, 2016 in the Indian Patent Office, and Indian Non-Provisional Application No. 201641000829, filed on Dec. 19, 2016 in the Indian Patent Office, the entire disclosure of each of which is hereby incorporated by reference.

### TECHNICAL FIELD

The embodiments herein relate to web content management and more particularly to a mechanism for management of media associated with a webpage rendered on an electronic device.

### BACKGROUND

Internet has become a source of all types of data and is used for various purposes such as entertainment and education. For example, there are many video hosting and sharing websites that allow users to view, share, and download videos. While some websites are free other websites charge for the contents being accessed by users.

Parameters such as number of users visiting a web site and number of viewers of a content being hosted by the website play a significant role in the website's revenue. However, the standards being used to construct most of the websites traditionally allow the contents to be downloaded, which means that the user is not required to visit the website again to access/view that content again and this affects the website's revenue. Further the website has no control over the downloaded content which results in unauthorized use of the content.

Media Source Extension (MSE) is a standard that was introduced to overcome the aforementioned drawback of the traditional standards. MSE binds video content to a webpage, which makes the probability of the content being downloaded from the webpage/website extremely low. MSE video, when accessed by a user, is rendered by a Java Script (JS) engine directly on an interface associated with the webpage. The user needs to access the webpage each time to access and view the content. Though this ensures that the webpage can track actions being performed on the media contents, a disadvantage of this method is that the video cannot be played on a pop-up window, which causes inconvenience to the users. This effectively degrades the user experience.

### SUMMARY

Aspects of the present disclosure are to address at least the above-mentioned problems and/or disadvantages and to provide at least the advantages described below. Accordingly, an aspect of the present disclosure is to provide a method and system for media management on a webpage, wherein a browser engine in an electronic device, rendering the webpage, can be configured to couple one or more media contents of the webpage to a browser enabling rendering of a selected media content among one or more media contents of the webpage on a pop-up window.

Another aspect of the present disclosure is to provide a method for tracking actions being performed on the media content, while the media content is being rendered on the pop-up window, wherein the tracking of the actions is enabled due to the coupling that allows the browser to render even a Media Source Extension (MSE) video on the pop-up window and ensure that the browser has the capability to track user interactions on the pop-up window.

Another aspect of the present disclosure is to provide a method for facilitating sharing of the media content over a chat application active on the electronic device while the media content is being rendered on the popup window, wherein the media content shared with another electronic device can be directly played on a pop-up window of the another electronic device.

Another aspect of the present disclosure is to provide a method for highlighting of text on the webpage that corresponds to the media content of the webpage currently being rendered on the pop-up window.

Another aspect of the present disclosure is to provide a method for generating one or more video cards for one or more media contents on each web card, wherein the browser engine can be configured to establish a coupling between a corresponding webpage and one or more video cards, which can be rendered on the pop-up window.

Another aspect of the present disclosure is to provide a method for providing a pop-up window history to view the history of one or more media contents played by the user in the pop-up window, wherein a media content replays on the pop-up window in response to selecting the media content from the popup window history.

Another aspect of the present disclosure is to provide the latest updates corresponding to the media content selected from the pop-up window history by fetching dynamic media content associated with the selected media content and rendering the dynamic media content on the pop-up window.

Another aspect of the present disclosure is to provide a method for queuing one or more web links selected from one or more source applications on the electronic device in a pop-up window playlist, wherein the media content corresponding to a selected web link from the pop-up window playlist can be directly rendered on the pop-up window and the remaining web links queued in the pop-up window playlist are played in a queued sequence, wherein the pop-up window displays an icon of the source application of the media content.

Another aspect of the present disclosure is to facilitate direct access to the source application from the pop-up window on detecting a gesture on the icon of the source application displayed on the pop-up window.

Another aspect of the present disclosure is to enable the browser to pop out automatically the currently playing video into the pop-up window when receiving an input for switching to a different application.

In accordance with an aspect of the present disclosure, a method is provided for managing media content of a webpage in an electronic device. The method comprises establishing a coupling of at least one media content of the webpage with a browser. Further, the method comprises receiving a request to render a media content from the webpage on a pop-up window and rendering the media content on the pop-up window using the established coupling between the media content and the webpage.

In accordance with another of the present disclosure, an electronic device is provided for managing media content of a webpage, wherein the electronic device comprises a browser engine managing a browser. The browser engine is configured to establish a coupling of at least one media content of the webpage with the browser. Further, the browser engine is configured to receive a request to render a media content from the webpage on a pop-up window. Further, the browser engine is configured to render the media content on the pop-up window using the established coupling between the selected media content and the webpage.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 illustrates a block diagram of a media content management system, according to an embodiment of the present disclosure;

FIG. 2 illustrates various components of a browser engine of the media content management system, according to an embodiment of the present disclosure;

FIG. 3 illustrates various components of a content management server of the media content management system, according to an embodiment of the present disclosure;

FIG. 4 is a flow diagram that depicts steps involved in the process of tracking actions on a content being rendered on a pop-up window, by a webpage, using the media content management system, according to an embodiment of the present disclosure;

FIGS. 5A-5C illustrate an example of pop-up window implementation to play a video content in the media content management system, according to an embodiment of the present disclosure;

FIGS. 6A-6C illustrate an example implementation to play MSE video content on a pop-up window using the media content management system, according to an embodiment of the present disclosure;

FIGS. 7A-7E illustrate an example implementation to provide direct access to MSE video contents of a webpage using the media content management system, according to an embodiment of the present disclosure;

FIG. 8 illustrates example implementation to provide direct access to MSE video contents of a webpage using the media content management system, according to an embodiment of the present disclosure;

FIG. 9 illustrates an example implementation for sharing the media content being rendered on the pop-up window over a chat application, according to an embodiment of the present disclosure; and

FIGS. 10 to 13 illustrate a plurality of use case scenarios, according to an embodiment of the present disclosure.

The same reference numerals are used to represent the same elements throughout the drawings.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but they are merely used by the inventor to enable a clear and consistent understanding of the present disclosure. Accordingly, it should be apparent to those skilled in the art that the following description of various embodiments of the present disclosure is provided for illustrative purposes only and not for the purpose of limiting the present disclosure as defined by the appended claims and their equivalents.

It is to be understood that the singular forms “a,” “an,” and “the” include the plural referents unless the context clearly dictates otherwise. Thus, for example, reference to “a component surface” includes reference to one or more of such surfaces.

It will be further understood that the terms “includes,” “comprises,” “including” and/or “comprising,” when used in this specification, specify the presence of stated features, integers, operations, elements and/or components, but they do not preclude the presence or addition of one or more other features, integers, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include operatively connected or coupled. As used herein, the term “and/or” includes any and all combinations and arrangements of one or more of the associated listed items.

Unless otherwise defined, all terms (including technical and scientific terms) used herein have the same meaning as commonly understood by one of ordinary skill in the art to which this disclosure pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

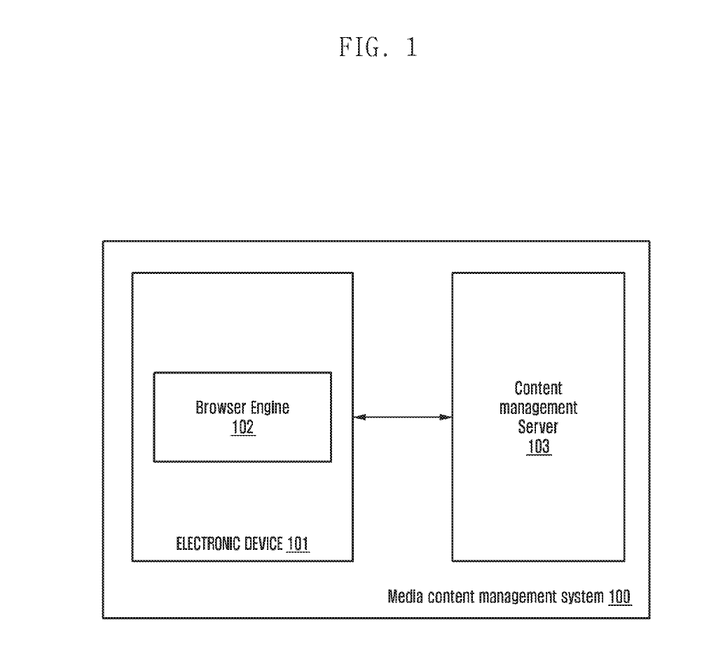

FIGS. 1 through 13, discussed below, and the various embodiments used to describe the principles of the present disclosure in this patent document are by way of illustration only and should not be construed in any way that would limit the scope of the disclosure. Those skilled in the art will understand that the principles of the present disclosure may be implemented in any suitably arranged communications system. The terms used to describe various embodiments are exemplary. It should be understood that these are provided to merely aid the understanding of the description, and that their use and definitions in no way limit the scope of the present disclosure. Terms first, second, and the like are used to differentiate between objects having the same terminology and are in no way intended to represent a chronological order, unless where explicitly stated otherwise. A set is defined as a non-empty set including at least one element

The embodiments of the present disclosure herein disclose methods and systems for managing media content of a webpage in an electronic device. A method comprises establishing, by a browser engine, a coupling of at least one media content of the webpage with the browser engine. Further, the method includes receiving, by the browser engine, a request to render a media content from the webpage on a pop-up window. Further, the method includes rendering, by the browser engine, the media content on the pop-up window using the established coupling between the media content and the webpage. Further, the method includes tracking, by the browser engine, one or more actions being performed on the media content, while the media content is being rendered on the pop-up window. The tracking of the actions is enabled due to the coupling that allows the browser to render even a Media Source Extension (MSE) video on the pop-up window and ensure that the browser has the capability to track user interactions on the pop-up window.

In the description, the method and system is explained under the assumption that the media content being rendered is the MSE video. However, MSE video is an example and not a limitation. The media content can be an audio content, a still image and the like.

In an embodiment, the electronic device can be a smartphone, a palmtop, a wearable device, a laptop and so on.

FIG. 1 illustrates a block diagram of a media content management system, according to an embodiment of the present disclosure.

The media content management system 100 includes a browser engine 102 of at least one electronic device 101, and a content management server 103. The browser engine 102 and the content management server 103 are configured to be in full-duplex communication to exchange/share at least one data associated with the content management process.

The browser engine 102 can be configured to provide at least an option for a user to interact with a browser application (browser) in the electronic device 101 to access all functionalities of the browser engine 102. The browser engine 102 can be further configured to allow user interaction with various web pages on the web and access contents on the webpages. The browser engine 102 can be further configured to provide and manage a pop-up window that can render contents on a webpage, upon receiving a user request. The browser engine 102 can be further configured to establish a coupling between the webpage from which the content is being rendered on the pop-up window and the pop-up window such that the webpage can track actions on the content being rendered even when the content is rendered on the pop-up window. The browser engine 102 can be further configured to display previously rendered MSE videos on a history window of the browser, and provide at least one interface for the user to access and initiate re-rendering of one or more of the MSE videos from the history window. The browser engine 102 can be further configured to provide at least one suitable interface for the user to provide input for different functionalities associated with the media content management being performed by the media content management system 100, using the browser in the electronic device 101. The browser engine 102 can be further configured to provide output of various functionalities being carried out by the media content management system 100, using suitable interface on the browser.

The content management server 103 can be configured to provide data as requested by the user. The content management server 103 can be further configured to support rendering of MSE video contents on the webpage on a pop-up window. The content management server 103 can be further configured to interact with the browser engine 102 and establish a coupling between the webpage from which the content is being rendered on the pop-up window and the pop-up window being managed by the browser engine 102; such that the webpage can track actions on the content being rendered even when the content is rendered on the pop-up window. The content management server 103 can be further configured to maintain data pertaining to MSE videos previously rendered by browser in each electronic device 101 as history data in an associated storage space, and permit the corresponding browser to access the data when needed. The content management server 103 can be further configured to support re-rendering of one or more of the MSE videos from the history window. The content management server 103 can be further configured to support dragging and dropping of a link and can be further configured to provide at least one suitable interface to provide input for different functionalities associated with the media content management being performed by the media content management system 100, using the browser in the electronic device 101. The content management server 103 can be further configured to check, upon receiving an input to render at least one MSE video on a link, whether the link has an updated content or not. The content management server 103 can be further configured to display the updated content. The content management server 103 can be further configured to track selection of at least one object on the content being rendered on the pop-up window, and in response, collect all or a fixed number of related contents and provide that information in a suitable format, so as to directly gain access to the related contents. The content management server 103 can be further configured to allow native applications in the electronic device 101 to render the MSE video and to track actions on the MSE video being rendered.

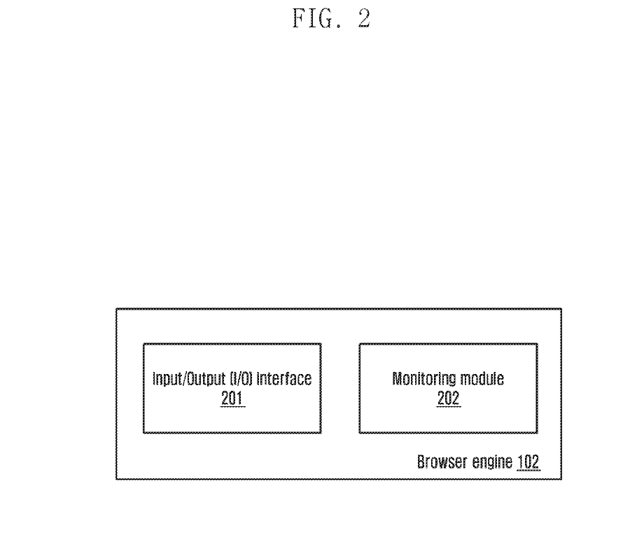

FIG. 2 illustrates various components of a browser engine of the media content management system, according to an embodiment of the present disclosure.

The browser engine 102 includes an Input/Output (I/O) interface 201 and a monitoring module 202.

The I/O interface 201 can be configured to provide sufficient channels and suitable protocols for the browser engine 102 to connect with at least one content management server 103 to perform data exchange for providing data access to users. The I/O interface 201 can be further configured to provide at least an option for a user to interact with and manage features of the browser engine 102 through a browsing application in the electronic device 101. For example, the I/O interface 201 can accept an input related to any of the functions supported by the browser engine 102, from a touch screen interface of the electronic device 101. The I/O interface 201 can be further configured to display results of any content management related action being performed by the browser engine 102.

The monitoring module 202 can be configured to monitor one or more contents being rendered on a pop-up window. The monitoring module 202 can be further configured to monitor and track one or more actions being performed on the pop-up window, and in turn on the content being rendered. For example, the monitoring module 202 tracks actions such as but not limited to play, pause, and other permitted actions while content is being rendered on the pop-up window. The monitoring module 202 can be further configured to detect and track an input pertaining to selection of one or more objects on the content being rendered on the pop-up window. The monitoring module 202 can be further configured to provide information pertaining to the detected action(s), as input to the content management server 103, through a coupling established between the webpage and the pop-up window, which allows the corresponding webpage to track actions being performed on the media content being rendered on the pop-up window.

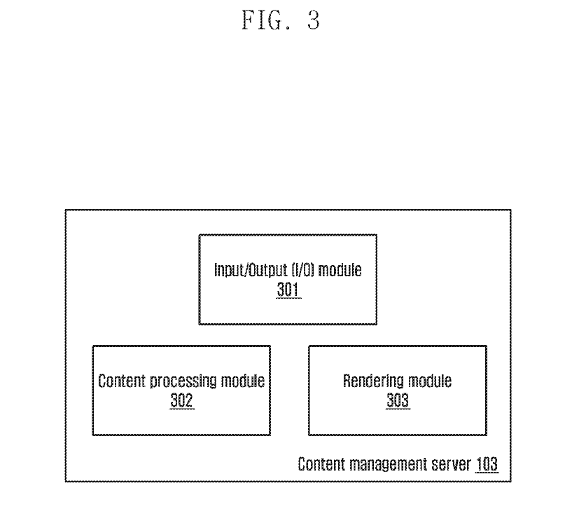

FIG. 3 illustrates various components of a content management server of the media content management system, according to an embodiment of the present disclosure.

The content management server 103 includes an Input/Output (I/O) module 301, a content processing module 302, and a rendering module 303.

The I/O module 301 can be configured to provide sufficient channels and suitable protocols for the content management server 103 to connect and communicate with at least one other entity. The entity can be at an electronic device 101, another content management server 103, or any such component that is associated with the content management process.

The content processing module 302 can be configured to perform various actions related to provisioning of the contents as well as data management, in response to at least one user input. The content processing module 302 can be further configured to collect information pertaining to one or more detected actions, from the monitoring module 202, and execute the corresponding action(s). The content processing module 302 can be further configured to provide instruction related to rendering of one or more contents to the rendering module 303.

The rendering module 303 can be configured to render one or more selected contents. The rendering module 303 can be further configured to provide at least one option for a user to initiate rendering of the content on a pop-up window, and in response to such a request, render the content on a pop-up window. In an embodiment, the content being rendered is MSE video.

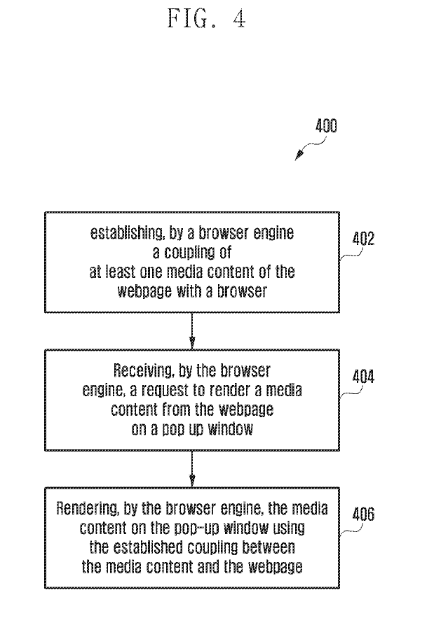

FIG. 4 is a flow diagram that depicts steps involved in the process of tracking actions on a content being rendered on a pop-up window, by a webpage, using the media content management system, according to an embodiment of the present disclosure.

At step 402, the method 400 includes establishing a coupling of at least one media content of the webpage with a browser. At step 404, the method 400 includes receiving a request to render the media content from the webpage on a pop-up window. At step 406, the method 400 includes rendering the media content on the pop-up window using the established coupling between the selected media content and the webpage. Further, the method 400 includes tracking one or more actions being performed on the media content, while the media content is being rendered on the pop-up window. The tracking of the actions is enabled due to the established coupling that allows the browser to render even the MSE video on the pop-up window and ensure that the browser has the capability to track user interactions on the pop-up window.

The actions being tracked allow the webpage to have statistical information such as number of views/hits of each media content even when the media content is rendered on the pop-up window. The media management system 100 can trigger certain features in response to the action(s) tracked. The various actions in method 400 may be performed in the order presented, in a different order or simultaneously. Further, in some embodiments, some actions listed in FIG. 4 may be omitted.

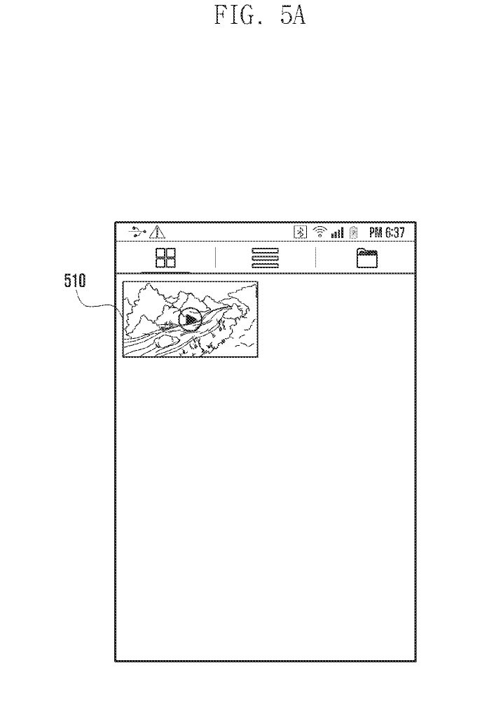

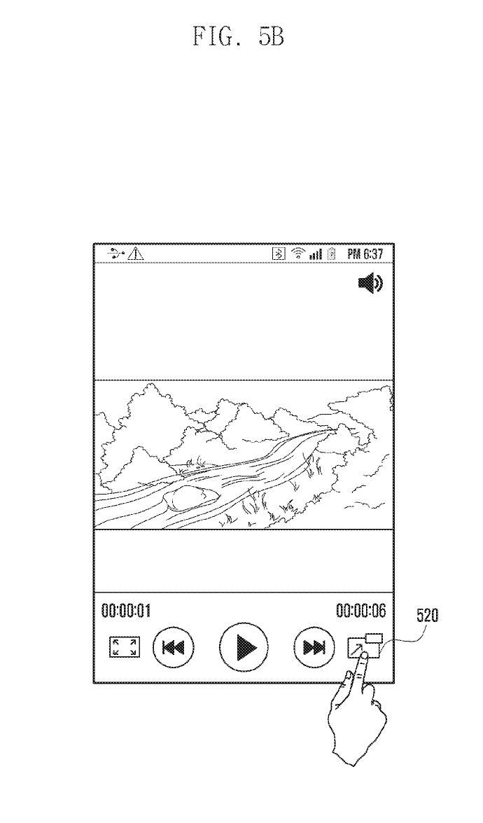

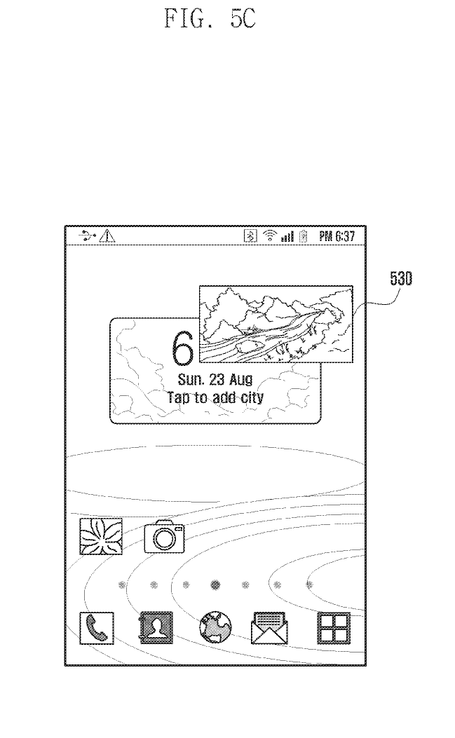

FIGS. 5a-5c illustrate an example pop-up window implementation to play a video content in the media content management system, according to an embodiment of the present disclosure.

In this example implementation, the user accesses a particular video content a thumbnail 510 of which is displayed in a suitable interface, as in 5a.

The video is rendered on a video player in response to a user input. Further, while the video is being rendered, an icon 520 to render the video on a pop-up window is displayed to the user as in 5b.

If the user selects the icon as in 5b, the video is rendered on the pop-up window 530 as in 5c. In an embodiment, the pop-up window 530 that renders the video can be played in the foreground of the display, above other applications that are open on the electronic device 101. This can facilitate multitasking that allows the user to view the video and use other applications at the same time. Further, as in 5c, the pop-up window 530 can be moved across the display screen by providing a suitable input. For example, the pop-up window 530 can be dragged and dropped from one part of the display screen to another.

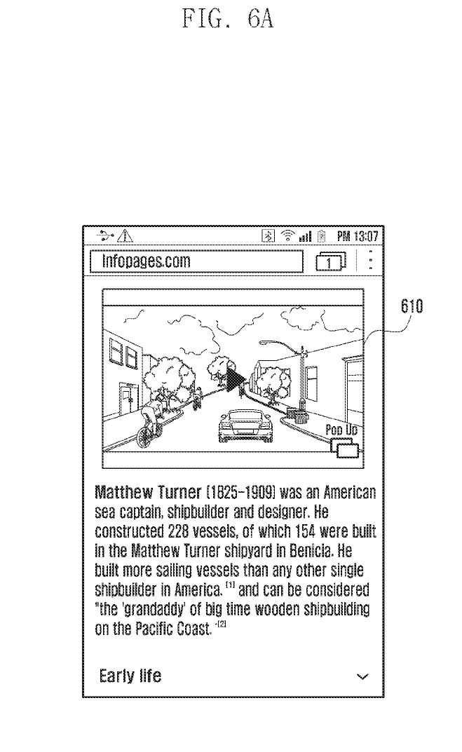

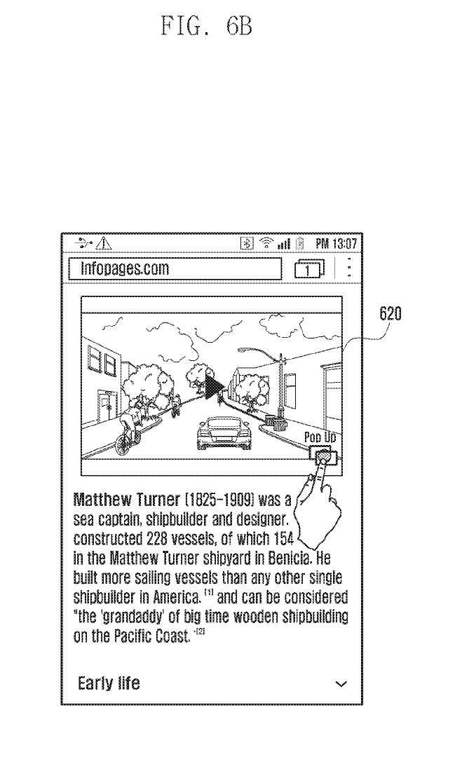

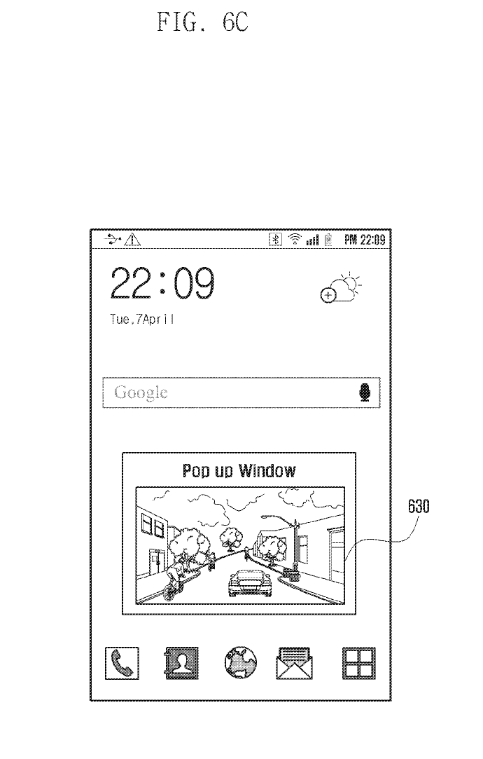

FIGS. 6a-6c illustrate an example implementation to play MSE video content on a popup window using the media content management system, according to an embodiment of the present disclosure.

Rendering of MSE video content 610 can be switched from a normal player to a pop-up window in response to a user input 620 as in 6a and 6b. Upon receiving the user input 620 to render the MSE video in the pop-up window 630, the rendering module 303, which in this embodiment is a Java Script (JS) engine, renders the MSE video on the pop-up window 630.

In an embodiment, a coupling is established and maintained between the webpage and the pop-up window 630, which allows the webpage to track all actions on the content, while the content is being rendered on the pop-up window 630. Further, the pop-up window 630 can be configured to remain on the foreground which allows the user access to one or more other applications on the electronic device 101 while the video is being rendered on the pop-up window 630 on the foreground as in 6c.

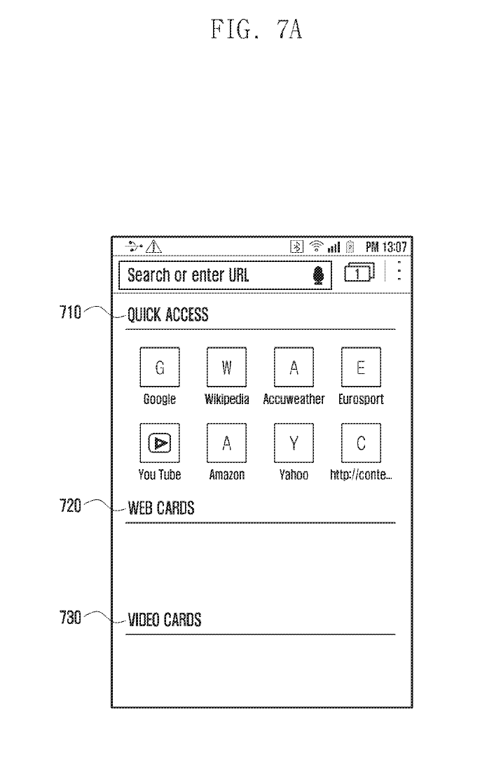

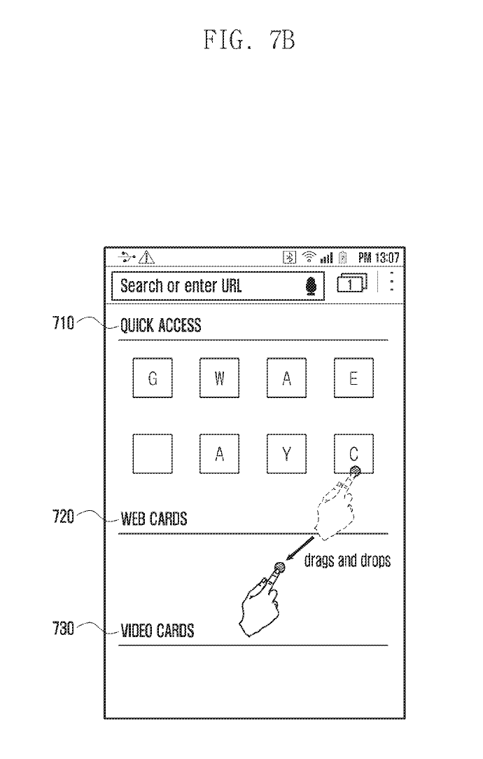

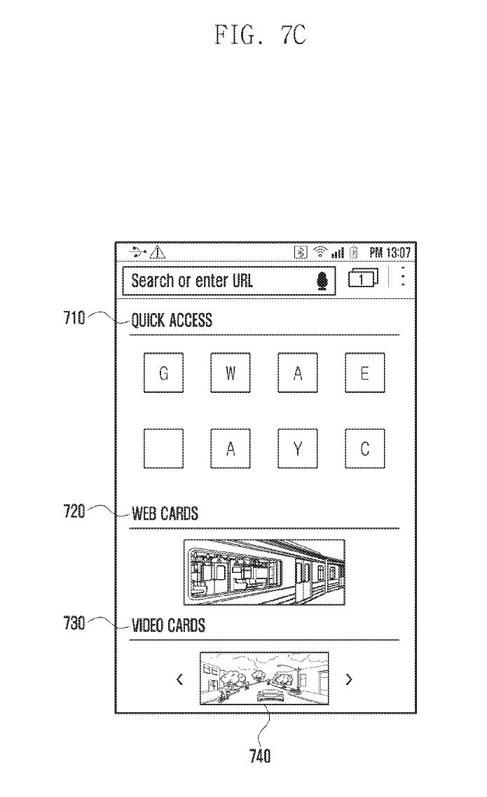

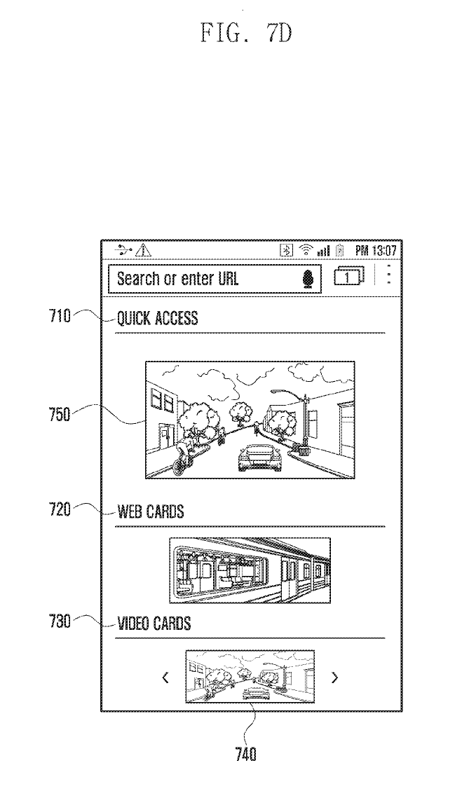

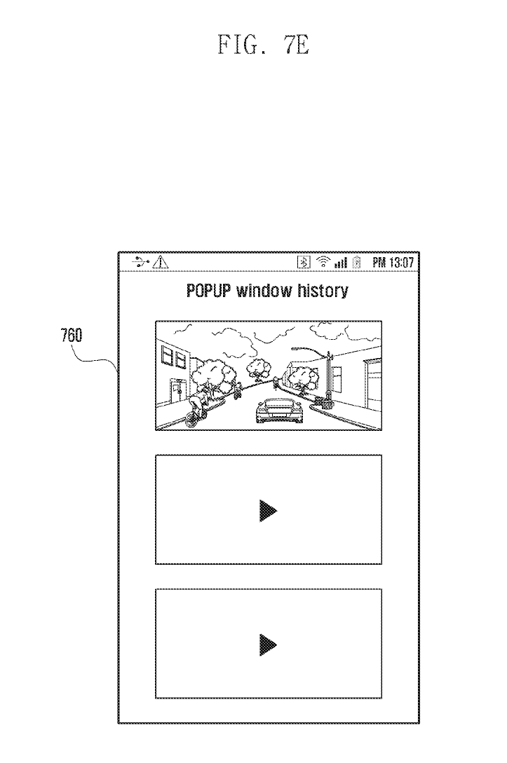

FIGS. 7a-7e illustrate an example implementation to provide direct access to MSE video contents of a webpage using the media content management system, according to an embodiment of the present disclosure.

The user is given an option to store links to different websites as bookmarks 710 as in 7a such that by accessing the link of a particular website, the corresponding webpage can be opened directly on the browser.

The user selects a particular bookmark “C”, and drags and drops the selected bookmark to a “web card” section 720 in the browsing application as in 7b which results in all video contents in that particular webpage being displayed in a “video cards” section 730 of the browsing application as in 7c. The user can directly access any video thumbnail 740 that is listed in the “video cards” section 730, and the selected video is being rendered on a pop-up window 750 as in 7d. Further, the user is provided with a pop-up window history 760 as in FIG. 7e to view a history of one or more media contents played by the user in the pop-up window 750, wherein the user can select a media content from the pop-up window history 760 for replaying on the pop-up window 750. Further, the selected media content from the pop-up window history 760 is played in the pop-up window 750.

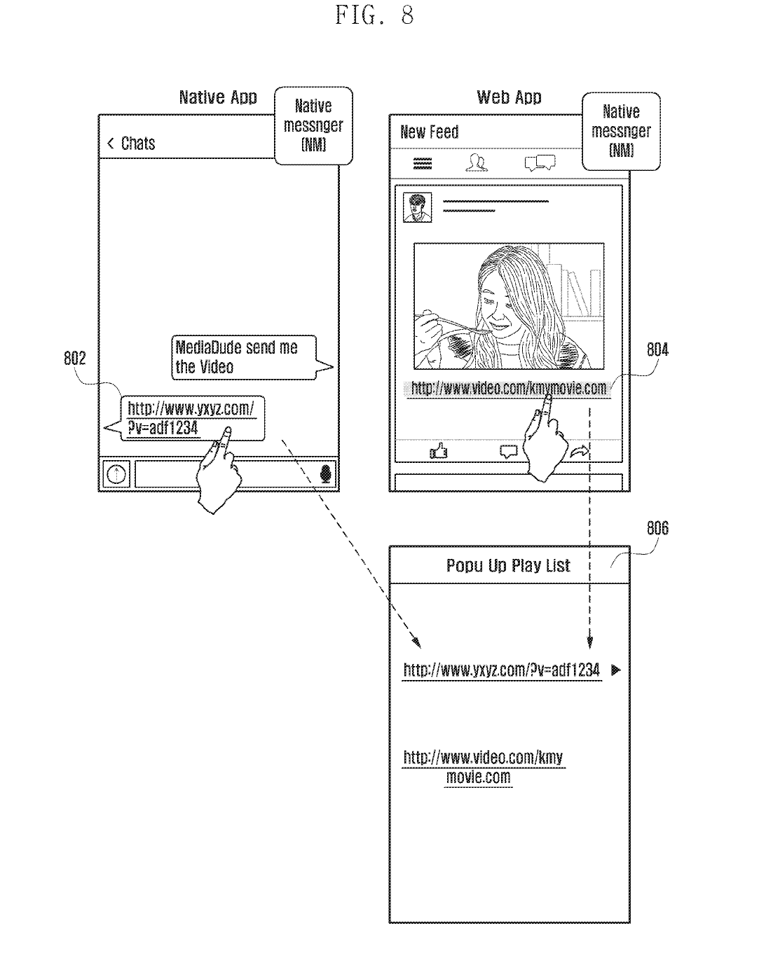

FIG. 8 illustrates an example implementation to provide direct access to MSE video contents of a webpage using the media content management system, according to an embodiment of the present disclosure.

In an embodiment, the browser engine 102 may provide the user with the latest updates corresponding to the media content selected from the pop-up window history by fetching dynamic media content associated with the selected media content and rendering the dynamic media content on the pop-up window.

As illustrated in FIG. 8, a user, using a suitable interface provided by the browser, can add one or more MSE videos or their corresponding web links to be rendered on the pop-up window to a pop-up window playlist 806 of the pop-up window, where the web links are queued. For example, two MSE video web links are added to the playlist, one each from source application 1 (Native Messenger) 802 and source application 2 (SocialMedia) 804. While an MSE video corresponding to weblink 802 is rendered on the pop-up window, the content management server 103 highlights and provides at least one interface to the source application from which the MSE video currently being rendered has been taken. The media content associated with the weblinks in the pop-up window playlist 806 may be played continuously in a queued sequence. Further, a gesture of drag and drop of a user of a selected weblink on a pop-up window being rendered currently can automatically add the corresponding weblink in the pop-up playlist 806.

Further, the user can launch or switch to the source application directly from the pop-up window, using the interface provided with actions such as an input gesture detected on the application icon on the pop-up window.

Further, the user can view a list of MSE videos previously rendered on the pop-up window, on a history page provided by the browser. The user can initiate rendering of one or more MSE videos directly from the history page. As well, the content management server 103 can check for updated contents, and render the contents on the pop-up window.

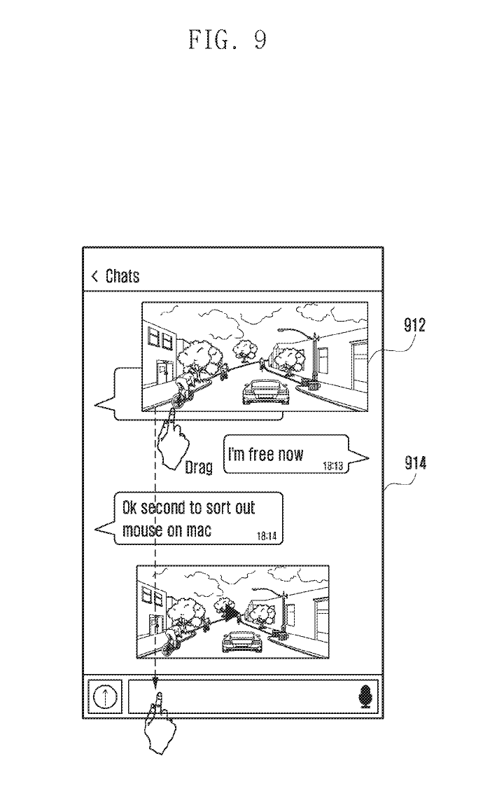

FIG. 9 illustrates an example implementation for sharing the media content being rendered on the pop-up window over a chat application, according to an embodiment of the present disclosure.

With reference to FIG. 9, the method facilitates the browser to share the media content 912 over a chat application 914 by a drag gesture (active on the electronic device) while the media content to be shared is being rendered on the pop-up window. The media content is shared with another electronic device over the chat application 914 and can be directly played on a pop-up window at the another electronic device.

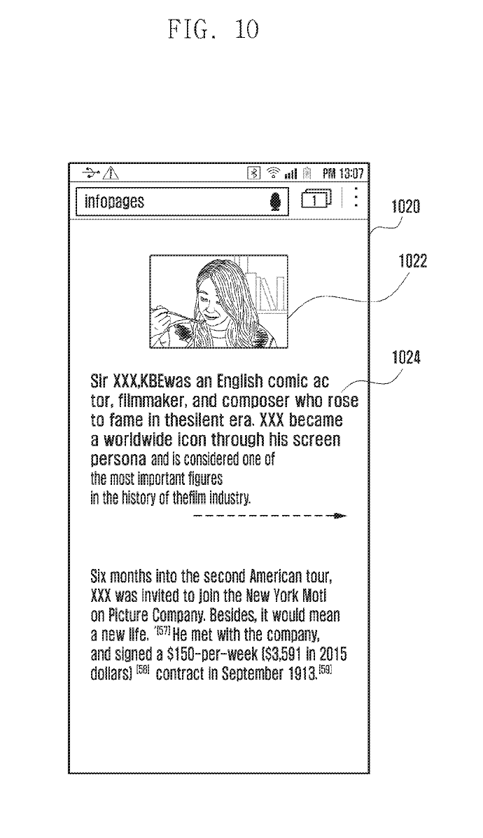

FIGS. 10 to 13 illustrate plurality of use case scenarios, according to an embodiment of the present disclosure.

As illustrated by FIG. 10, a user may request a page upload such as “infopages” 1020 that includes multiple embedded videos. As depicted in FIG. 10, the method allows the browser to highlight text 104 on the webpage that corresponds to the media content of the webpage currently being rendered on the pop-up window 1022 (selected from the videos of the webpage that is loaded by the browser). This enhances readability. Thus, as the user switches to another media content, the text corresponding to that media content is highlighted.

In an embodiment, the browser automatically pops out the currently playing video into a pop-up window when the user switches to a different application. For example, if the user, who is watching the XXX Chaplin video from the infopages, switches from the infopage to a SocialMedia (SM) application, the browser automatically pops out the XXX Chaplin video on the pop-up window as an overlay on the SocialMedia app. In another example, the user may be listening to a song on YouTube and a Native Messenger (NM) message arrives. The user pulls down the notification bar and selects Native Messenger message. The electronic device switches to Native Messenger and the browser automatically pop-up the current video that is being played.

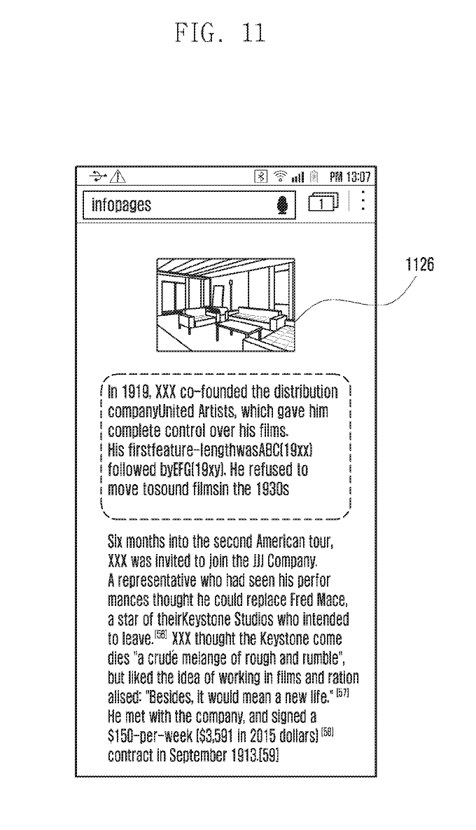

Further, with reference to FIG. 11, if the user selects a specific content loaded by the webpage, the method allows automatic playing of a related video 1126 of the webpage.

Further, the user can perform a live interaction with the MSE video while the MSE video is being rendered on the pop-up window. For example, the user selects a particular frame of the MSE video being rendered on the pop-up window by providing a suitable type of input (for example tapping on the pop-up window). The content management server 103 that manages the webpage from which the MSE video is being rendered can track the user input by virtue of the coupling of the “MSE video being rendered” with the webpage, and identify and trigger at least one action in response to the user input received.

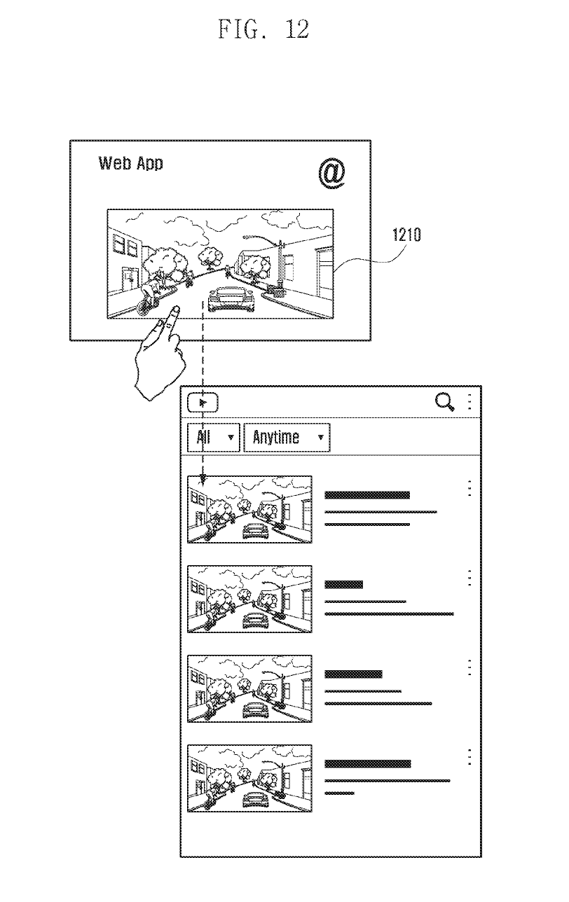

With reference to FIG. 12, the content management server 103 captures and processes the frame 1210 selected by the user, searches for contents that match the selected frame 1210, and present the contents to the user. Such user inputs and corresponding actions can be configured with the content management server 103.

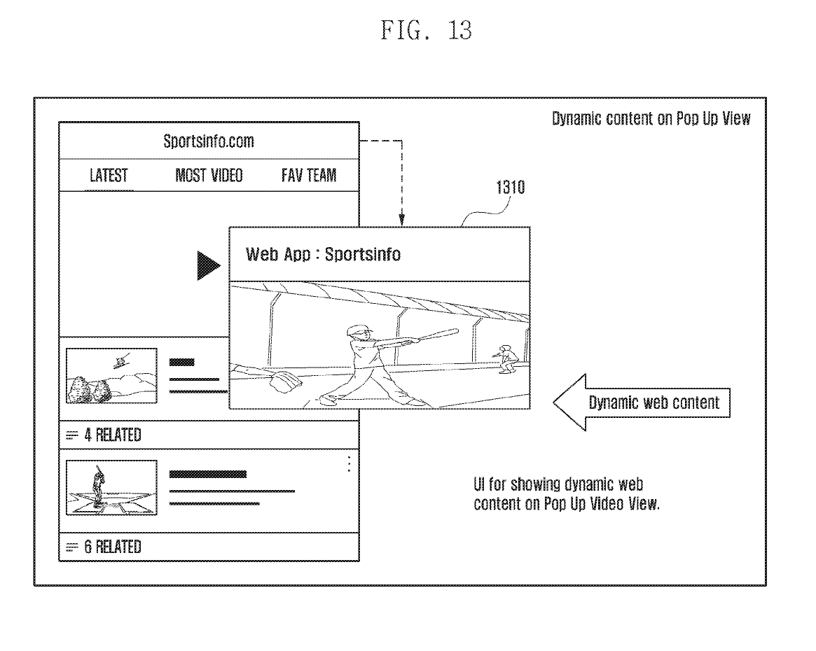

Further, the user initiates rendering of a particular MSE video on the pop-up window 1310 as depicted in FIG. 13, by clicking on or by dragging and dropping a web link to the video to be rendered. Upon receiving the user input to render the MSE video, the content management server 103 checks if there is an updated content on the link selected by the user. Further, if there is an updated content, the content management server 103 can render the updated content on the pop-up window 1310 of the browser.

The embodiments disclosed herein can be implemented through at least one software program running on at least one hardware device and performing network management functions to control the network elements. The elements shown in FIG. 1 through 13 include blocks which can be at least one of a hardware device, or a combination of a hardware device and a software module.

The embodiments disclosed herein specify a mechanism for web content management. The mechanism allows establishment and maintenance of a coupling between a webpage and a pop-up window on which a content from the webpage is being rendered to allow the webpage to track the actions on the content being rendered on the pop-up window, and provides a system thereof. Therefore, it is understood that the scope of protection is extended to such a system, and by extension, to a computer readable means having a message therein, said computer readable means containing a program code for implementation of one or more steps of the method, when the program runs on a server or mobile device or any suitable programmable device. The method is implemented in a preferred embodiment using the system together with a software program written in, for example, Very high speed integrated circuit Hardware Description Language (VHDL), another programming language, or implemented by one or more VHDLs or several software modules being executed on at least one hardware device. The hardware device can be any kind of device that can be programmed including, for examples, any kind of a computer such as a server or a personal computer or any combination thereof, for example, one processor and two FPGAs. The device may also include means that could be, for example, hardware means such as an ASIC or a combination of hardware and software means, an ASIC and an FPGA, or at least one microprocessor and at least one memory with software modules located therein. Thus, the means are at least one hardware means or at least one hardware-cum-software means. The method embodiments described herein could be implemented in pure hardware or partly in hardware and partly in software. Alternatively, the embodiment may be implemented on different hardware devices, for example, using a plurality of CPUs.

The foregoing description of the specific embodiments will so fully reveal the general nature of the embodiments herein that others can, by applying current knowledge, readily modify and/or adapt for various applications such specific embodiments without departing from the generic concept therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the claims as described herein.

What is claimed is:

1. A method for managing media content of a webpage in an electronic device, the method comprising:
establishing, by a browser engine, a coupling of at least one media content of the webpage with a browser;
receiving, by the browser engine, a request to render a media content from the webpage on a pop-up window; and
rendering, by the browser engine, the media content on the pop-up window using the established coupling between the media content and the webpage.

2. The method of claim 1,
wherein the at least one media content is a Media Source Extension (MSE) video and the established coupling is a deep coupling that enables sourcing the media content, to be rendered on the pop-up window, from a content management server, and
wherein the established coupling enables the browser and the webpage to track user actions performed on the media content while the media content is being rendered on the pop-up window.

3. The method of claim 1, further comprising:
handling, by the browser engine, at least one action with respect to the media content being rendered on the pop-up window on detecting an input gesture,
wherein the at least one action comprises sharing of the media content rendered on the pop-up window over a chat application to another electronic device, and
wherein the another electronic device renders the media content, received in the chat application, in a pop-up window on the another electronic device.

4. The method of claim 1, wherein the method comprises highlighting, by the browser engine, a text associated with the media content when the media content is being rendered on the pop-up window.

5. The method of claim 1, wherein the method comprises generating, by the browser engine, at least one video card for at least one media content on each web card generated for each web page browsed,
wherein the coupling is established between each webpage and corresponds to the at least one video card, and
wherein the at least one video card is rendered on the pop-up window when the at least one video card is selected.

6. The method of claim 1, wherein the method comprises providing, by the browser engine, a pop-up window history to view history of at least one media content played in the pop-up window, and
wherein a media content is replayed on the pop-up window in response to selecting the media content from the pop-up window history.

7. The method of claim 6, wherein the method comprises providing, by the browser engine, latest updates corresponding to the media content selected from the pop-up window history by fetching dynamic media content associated with the selected media content and rendering the dynamic media content on the pop-up window.

8. The method of claim 1, wherein the method comprises queuing, by the browser engine, at least one web link selected from at least one source application on the electronic device in a pop-up window playlist,
wherein a media content corresponding to a web link queued in the pop-up window playlist is directly rendered on the pop-up window and remaining queued web links in the pop-up window playlist are played in a queued sequence, and
wherein the pop-up window displays an icon of a source application of the media content.

9. The method of claim 8, wherein the method comprises switching, by the browser engine, to the source application on detection of an input gesture on the icon displayed in the pop-up window.

10. The method of claim 1, wherein the browser automatically pops out a currently playing video into the pop-up window when an input for switching to a different application is received.

11. An electronic device for managing media content of a webpage, the electronic device comprising a browser engine managing a browser, wherein the browser engine is configured to:
establish a coupling for at least one media content of the webpage with the browser;
receive a request to render a media content from the webpage on a pop-up window; and
render the media content on the pop-up window using the established coupling between the media content and the webpage.

12. The electronic device of claim 11, wherein the at least one media content is a Media Source Extension (MSE) video and the established coupling is a deep coupling that enables sourcing the media content, to be rendered on the pop-up window, from a content management server, and
wherein the established coupling enables the browser and the webpage to track user actions performed on the media content while the media content is being rendered on the pop-up window.

13. The electronic device of claim 11, wherein the browser engine is configured to:
handle at least one action with respect to the media content being rendered on the pop-up window on detecting an input gesture,
wherein the at least one action comprises sharing of the media content rendered on the pop-up window over a chat application to another electronic device, and
wherein the another electronic device renders the media content, received in the chat application, in a pop-up window on the another electronic device.

14. The electronic device of claim 11, wherein the browser engine is configured to highlight a text associated with the media content when the media content is being rendered on the pop-up window.

15. The electronic device of claim 11, wherein the browser is configured to generate at least one video card for at least one media content on each web card generated for each web page browsed,
wherein the coupling is established between each webpage and corresponds to the at least one video card, and
wherein the at least one video card is rendered on the pop-up window when the at least one video card is selected.

16. The electronic device of claim 11,
wherein the browser engine is configured to provide a pop-up window history to view history of at least one media content played in the pop-up window,
wherein a media content is replayed on the pop-up window in response to selecting the media content from the pop-up window history.

17. The electronic device of claim 16, wherein the browser engine is configured to provide latest updates corresponding to the media content selected from the pop-up window history by fetching dynamic media content associated with the selected media content and rendering the dynamic media content on the pop-up window.

18. The electronic device of claim 11, wherein the browser engine is configured to queue at least one web link selected from at least one source application on the electronic device in a pop-up window playlist,
wherein a media content corresponding to a web link queued in the pop-up window playlist is directly rendered on the pop-up window and remaining queued web links in the pop-up window playlist are played in a queued sequence, and
wherein the pop-up window displays an icon of a source application of the media content.

19. The electronic device of claim 18, wherein the browser engine is configured to switch to the source application on detection of an input gesture on the icon displayed in the pop-up window.

20. The electronic device of claim 12, wherein the browser engine is configured to automatically pop out a currently playing video into a pop-up window when an input for switching to a different application is received.
